(19) United States
(12) Patent Application Publication
(10) Pub. No.: US 2016/0021249 A1
(43) Pub. Date: Jan. 21, 2016

(54) SYSTEMS AND METHODS FOR CONTEXT BASED SCREEN DISPLAY

(71) Applicant: EBAY INC., San Jose, CA (US)

(72) Inventors: Shailesh Dinkar Govande, Milpitas, CA (US); Madhura Pravin Tipnis, Tel Aviv (IL)

(21) Appl. No.: 14/335,640

(22) Filed: Jul. 18, 2014

(51) Int. Cl. H04M 3/436; H04M 3/22; H04W 4/16

(52) U.S. Cl. CPC H04M 3/436; H04W 4/16; H04M 3/4365; H04M 3/2281

(57) ABSTRACT

A system or method is provided to determine and display information to a user based on a telephone conversation of the user. In particular, the system or method may monitor and analyze a telephone conversation of the user to determine the context of the conversation and display appropriate user interface or information to the user without user's intervention or input. In an embodiment, the system or method may monitor the user's interactions with the mobile device to learn the user's preferences and routines for screen display. As such, the system or method may predict or anticipate the user's need for screen display.

### BACKGROUND

1. Field of the Invention

The present invention generally relates to systems and methods for context based screen display on a mobile device.

2. Related Art

Many mobile devices, such as smart phones, are capable of multitasking, such as facilitating telephone calls and executing various mobile applications at the same time. For example, the user may use a mobile device to make a telephone call and perform online searches on a browser application at the same time. However, during a telephone conversation, the user may have to press additional keys on the mobile device to activate a desired application or to display desired information. This may cause inconvenience for the user during a phone conversation. Thus, there is a need for a system or method that implements context based screen display on a mobile device during a telephone call.

### BRIEF DESCRIPTION OF THE FIGURES

FIG. 1 is a block diagram of a networked system suitable for implementing a process for context based screen display on mobile devices call routing according to an embodiment.

FIG. 2 is a flowchart showing a process for setting up context based screen display on mobile devices according to one embodiment.

FIG. 3 is a flowchart showing a process for context based screen display on mobile devices according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or method is provided to determine and display information to a user based on a telephone conversation of the user. In particular, the system or method may monitor and analyze a telephone conversation of the user to determine the context of the conversation and display appropriate user interface or information to the user without user's intervention or input. In an embodiment, the system or method may monitor the user's interactions with the mobile device to learn the user's preferences and routines for screen display. As such, the system or method may predict or anticipate the user's need for a particular type of screen display or content on a display.

In an embodiment, the system or method may monitor and analyze the user's telephone conversation with one or more third parties to determine the context of the conversation and to display the appropriate information based on the context. In particular, the system or method may use voice recognition techniques to identify keywords or key phrases and to analyze the keywords or key phrases to determine the context of the telephone conversation. For example, when the system or method recognizes the phrase or keywords related to entering numbers or other information, the system or method may automatically cause the user's mobile device to display input mechanisms, such as a virtual key pad or keyboard, automatically to allow the user to enter information. Thus, the user does not have to manipulate or press other buttons to activate the input mechanism.

In another example, the system or method may monitor the user's interaction with the mobile device and learn the user's preferences and habits for determining a screen display. For example, the system or method may monitor how and when the user activates or displays a certain feature or application on the mobile device. Thus, the system or method may anticipate and predict when the user would desire to have the same or similar display or application. In an embodiment, the system or method may display and also auto-fill forms or fields that are routinely filled out by the user.

In an embodiment, by monitoring the phone conversation, the system or method may recognize the user's need to display or activate certain applications, such as a calendar application, a search engine, a contact/address application, an email application, a messaging application, and the like. As such, the system or method may automatically activate or display the appropriate application or features for the user's convenience.

In an embodiment, the system or method may monitor and analyze a telephone conversation between the user and another user and may determine that the user likely would like to view certain information, such as pictures or videos, or that the user likely would like to hear certain audio recordings. The system or method may then automatically display or play the pictures, videos, or audio recordings to the user. In an embodiment, the system or method may determine that the user likely would like to find certain information. The system or method may automatically search and find the information desired by the user and may present the information to the user.

In an embodiment, the system or method may monitor and analyze the telephone conversation of the user at the user's mobile device and may present the information to the user on another device communicatively connected to the user's mobile device. For example, the user may use a smart phone to make a phone call and the context based information may be displayed to a tablet that is connected to the smart phone via Near-Field Communication (NFC), such as Bluetooth.

In an embodiment, the system or method may monitor and analyze the telephone conversation of the user and may determine that the user would like to view a location or map of the user with respect to other places. The system or method may then activate a map or Global Positioning System (UPS) application to locate the user and to display the location of the user to the user. For example, the system or method may automatically display the location of the user relative to certain amenities desired by the user. In another example, the system or method may automatically display a map indicating the location of the user relative to the location of another caller.

In an embodiment, the system or method may monitor and analyze the telephone conversation of the user and may display appropriate or customized advertisements to the user. The advertisements may be tailored to the user based on the phone conversation. For example, when the user is put on hold by a service provider company, the system or method may automatically display relevant advertisements to the user while the user is being put on hold.

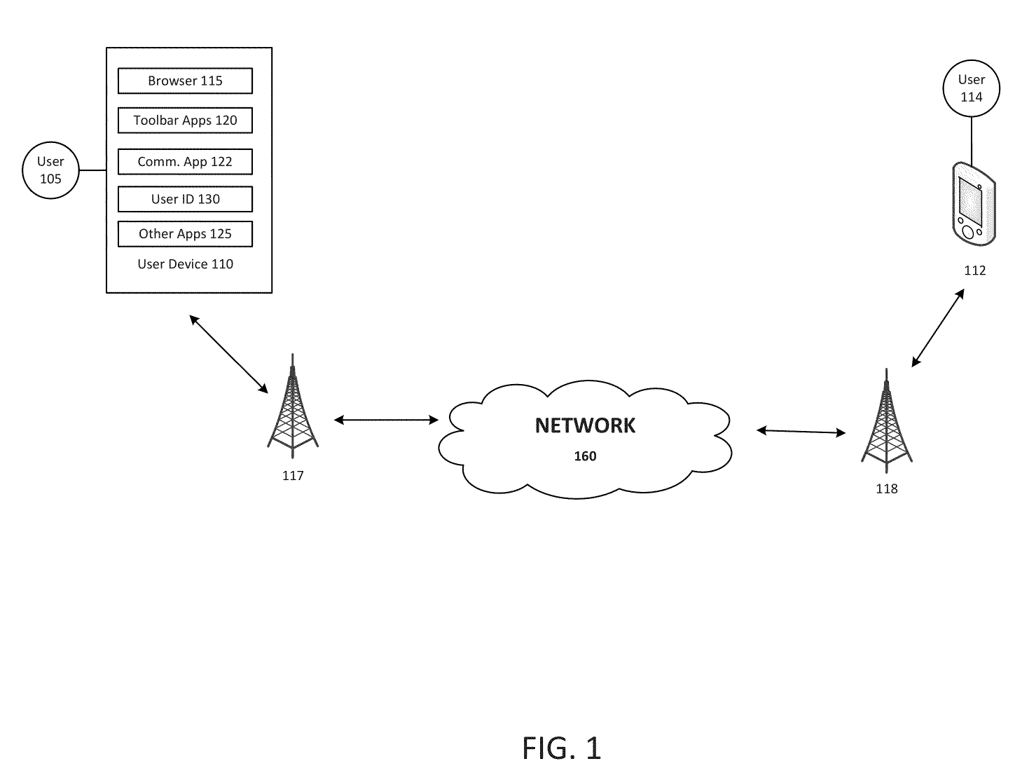

FIG. 1 is a block diagram of a networked system 100 suitable for implementing a process for context based screen display on mobile devices according to an embodiment. Networked system 100 may comprise or implement a plurality of communication devices, servers, and/or software components that operate to perform various telephone communications. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a phone device 112, and cellular towers 117 and 118 in communication over network 160. A user 105 may utilize user device 110 to perforin telephone communication via network 160. A user 105 may utilize user device 110 to initiate and receive telephone calls. Similarly, user 114 may use telephone device 112 to initiate and receive telephone calls. Network 160 may be a Public Switch Telephone Network (PSTN) including various telephone lines, fiber optic cables, cellular networks, communication satellites connected by switching/routing centers. In some embodiments, network 160 may include an Internet Protocol (IP) network configured to facilitate Voice over IP (VoIP) communications.

A telephone call may be initiated from telephone device 112. For example, the user 114 may dial a phone number of user device 110 at telephone device 112. Thus, the telephone call may be designated for user device 110. The call may be routed through network 160 to user device 110. In particular, user device 110 is within the cellular area of cellular tower 117 and is connected to cellular tower 117. Thus, the telephone call from telephone device 131 may be routed to user device 110 via cellular tower 117.

User device 110 and telephone device 112 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

User device 110 may be implemented using any appropriate hardware and software configured for wired and/or wireless communication in the system 100. For example, in one embodiment, user device 110 may be implemented as a personal computer (PC), a smart phone, wearable device, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over network 160, such as a user account for setting up a shopping list and/or merchant sites for viewing and purchasing products and services. User device 110 may also include one or more toolbar applications 120 which may be used, for example, to provide client-side processing for performing desired tasks in response to operations selected by the user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160. User device 110 includes one or more user identifiers 130 which may be implemented, for example, as operating system registry entries, cookies associated with browser application 115, identifiers associated with hardware of user device 110, telephone number associated with user device 110 or other appropriate identifiers, such as used for payment/user/device authentication. In one embodiment, user identifier 130 may be used by a telephone communication service provider to associate user 105 with a particular telephone account maintained by the telephone communication service provider.

User device 110 may include a communications application 122, with associated interfaces, enables user device 110 to communicate within system 100. For example, the communications application 112 may be configured to manage and implement wired communication, such as Ethernet communication and/or telephone landline communication, and wireless communication, such as WiFi communication, Bluetooth communication, cellular voice and/or data communication, Near-Field Communication (NFC), and the like.

User device 110 also may include applications that collect location data using Global Positioning System (GPS) to identify a location of user device 110. User device 110 may have a magnetometer configured to detect a moving or traveling direction of user device 110. Other means for collecting location data, such as WiFi devices, Near-Field Communication (NFC) devices, or the like also may be included in user device 110 for determining a location of user device 110. Thus, user device 110 may determine a current location of user device 110 and track a traveling direction of the user device 110 based on the collected location data. Telephone device 112 may have one or more similar components as that of user device 110.

Cellular towers 117 and 118 may be operated by one or more telecommunication service providers. Cellular towers 117 and 118 may be configured to manage communication for cellular telephone devices located within the cellular tower 117's and 118's respective broadcast ranges. Cellular towers 117 and 118 may have access to network 160 and may provide internet and/or telephone services to cellular devices within their respective broadcast ranges. Telephone device 112 may be located within the broadcast range of cellular tower 118 and configured to facilitate cellular or data communication with cellular tower 118. Thus, communication device 112 may initiate and/or receive telephone calls by connecting to the cellular tower 118. In another embodiment, one or more of the user device 110 and the telephone device 112 may be connected directly to the telephone network 160 via telephone landlines without using the cellular towers 117 and/or 118.

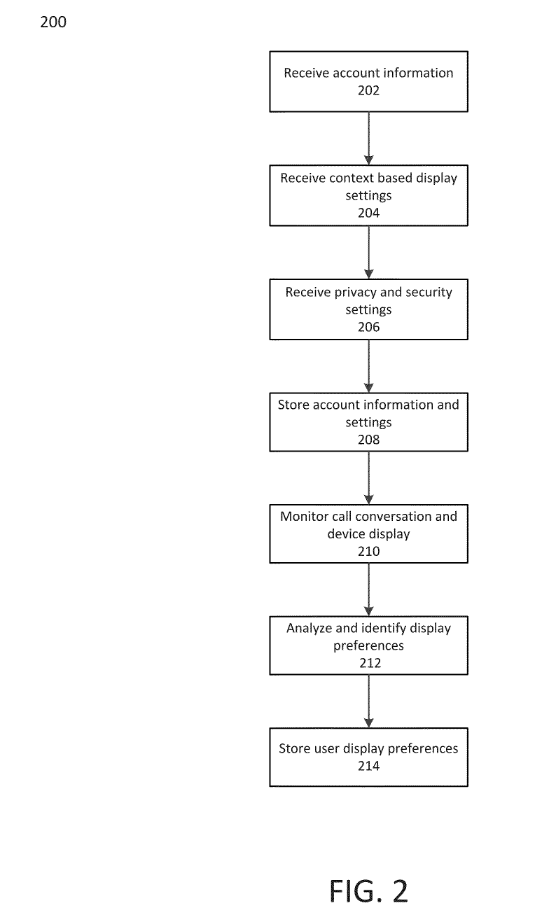

FIG. 2 is a flowchart showing a process 200 for setting up a context based screen display on mobile devices according to one embodiment. At step 202, user device 110 may receive telephone account information. For example, when a new telephone account is set up, the telephone account may be registered via the user device 110. In an embodiment, the telephone account may be set up at a server (not shown) of a telecommunication service provider. Telephone account information may include a telephone number assigned to a telephone device, user information, service plan information, voice mail settings, telephone device type and model, context based display settings and preferences. Context based display settings may allow the user 105 to choose whether to activate context based screen display during a telephone call. Context based display settings also include parameters for determining when and what types of information should be displayed. Context based display settings also include parameters for privacy. For example, privacy settings may include settings related to what kind of personal information may be analyzed for context display.

At step 204, the user device 110 may receive context based display settings. For example, a user input interface may be provided at user device 110 to receive user input for context based display settings associated with the user device 110. The context based display settings may include the types of information or application that may be displayed automatically as triggered by a telephone conversation. For example, user 105 may allow calendar applications, web browsers, video/audio player applications, and the like to be displayed or activated during a telephone conversation. The context based display settings may also include options for the user device 110 to auto-fill certain forms. For example, when a fillable form or field is displayed, the user device 110 may automatically fill in the appropriate information for the convenience of the user 105.

At step 206, the user device 110 may receive privacy and security settings. A user input interface may be provided at user device 110 to receive user input for privacy and security settings for context based display. For example, the user 105 may be allowed to choose whether the user's location, pictures, status, or other private information may be accessed and analyzed for context based display at the user device 110 and/or at another device in telephone communication with the user device. In an embodiment, the user 105 may select what types of information may be displayed. For example, the user 105 may select whether audio, video, advertisements, and other types of information may be displayed or played to the user. In an embodiment, the user 105 may be allowed to select other display devices at which the context based information may be displayed. For example, the user device 110 may be connected to a monitor screen, and the context based information may be displayed on this monitor screen.

At step 208, user device 110 may store the account information including the various context based display settings. The account information may be associated with user 105's account. In an embodiment, the account information may be stored at a server of a telecommunication or other service provider. The server may store a plurality of user accounts each with its account information and context based display settings.

At step 210, user device 110 may monitor telephone call conversation and device display. For example, user device 110 may monitor telephone call conversation to learn the user 105's voice, phrases, terminologies, accents, and the like. In particular, user device 110 may identify certain keywords or key phrases used by the user 105. In an embodiment, user device 110 also or alternatively may identify certain keywords or key phrases used by the other caller. User device 110 also may learn the user 105's tone voice or the other caller's tone of voice. For example, the same phrases may have different meanings based on the tone of voice, such as a tone of voice for a question or a statement. The tone of voice also may be used to determine the user 105's or the other caller's emotion. For example, the tone of voice may indicate that the user 105 is exited, angry, in a hurry, or any other emotion or mental state.

The user device 110 may monitor the user 105's interaction with the user device 110 in conjunction with the telephone conversation to learn the user 105's display preferences. For example, the user device 110 may learn that, when the user 105 uses keywords like “schedule,” “appointment,” “calendar,” or the like in the telephone conversation, the user 105 likely will activate and display the calendar application. Thus, the user device 110 may associate these keywords with the observed display or application.

At step 212, the user device 110 may analyze and identify application or display preferences based on the monitored telephone conversation. The user device 110 may identify display or application activation after the user 105 or the other caller mentions certain keywords or key phrases. For example, when the other caller, such as a service provider, requests that the user 105 enters his or her account number during a telephone conversation, the user device 110 may observe that the user activates a virtual keypad or keyboard to be displayed on the screen to receive the user's account number. The user device 110 may learn, after observing such interactions repeatedly, that the user 105 very likely wants to activate and display the keypad or the keyboard when the other caller says such keywords or key phrases. In an embodiment, the user device 110 may monitor the user 105's telephone conversation and the user 105's interaction with the user device 110 and may determine probabilities that a certain information or application should be displayed when certain keywords or key phrases are used in the telephone conversation.

At step 214, the user device 212 may store these user preferences for context based display. The user device 212 may continuously learn and update the user 105's preferences for context based display during telephone calls such that the user device 212 is updated with the most recent and relevant display preferences for the user 105. In another embodiment, a server of a service provider, such as a payment service provider or a telecommunication service provider, may monitor and analyze the user 105's telephone conversations and the user 105's interactions with the user device 110 and may determine, store, and update the user 105's context based display preferences.

Accordingly, a user account may be set up for the user 105. The user account may include various settings for implementing context based display for the user 105 during a telephone conversation. Further, the user 105's telephone conversations and the user 105's interactions with the user device 110 may be monitored and analyzed to determine user preferences for context based display. These user preferences may continuously be learned and updated.

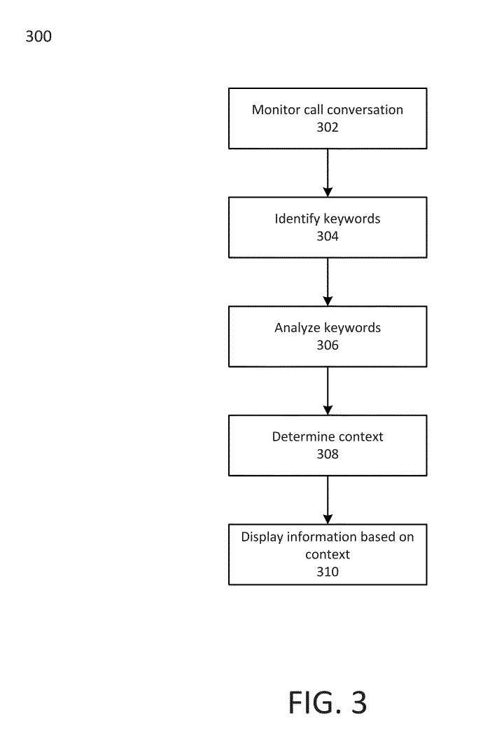

FIG. 3 is a flowchart showing a process 300 for context based screen display on mobile devices according to one embodiment. At step 302, the user device 110 may monitor a call conversation. In particular, when the user 105 initiates or accepts a telephone call on the user device 110, the user device 110 may identify the other caller or callers. For example, the other caller may be an individual or a service provider, such as a customer service of a company or an organization. The user device 110 may utilize caller ID to identify the other caller.

In an embodiment, the user device 110 also may determine the context of the telephone call. In particular, the user device 110 may determine the time, location, date, season of the call. For example, if the call is made when the user 105 is at work, the context of the call may likely be work related. If the call is made when the user 105 is at home, the context of the call may likely be personal matters. If the call is made when the user 105 is traveling to a new location, the context of the call may likely be travel related. Whether the call is made during business hours or during non-business hours also may indicate the context of the phone call. In another example, the types of location where the call is made also may give context to the call. The call may be made in a shopping location, a public performance event, at a merchant's store, or various types of locations. These different types of location where the call is made also may give context to the telephone call.

In an embodiment, the user device 110 may track the movement of the user 105 via a GPS device included on the user device 110. Based on the movement of the user 105, the user device 110 may infer or determine the context of the telephone call. For example, the user device 110 may detect that the user 105 is moving at a high speed, e.g., above 45 mph, and may determine that the user 105 is traveling on a highway based on the user 105's location. Thus, the user 105's movement may provide context to the telephone conversation. The user device 110 also may include other sensors, such as light sensor, temperature sensor, barometer, and the like. The user device 110 may collect environmental data via these sensors to provide context to the telephone conversation. For example, the temperature, altitude, weather, ambient light, and other environment factors detected around the user device 110 may provide context to the telephone conversation. In an embodiment, the user device 110 may obtain other environmental information via the internet from weather service providers. The environmental information, such as weather forecast, may provide context to the telephone conversation.

In an embodiment, the user 105's interactions with the user device 110 just before the user 105 initiates or accepts a call may give context to the telephone call. In particular, the user device 110 may monitor and remember the user 105's interaction with the user device 110 before a call is made and may analyze the user 105's interaction to provide context to the telephone call. For example, the user 105 may perform searches for locations, merchants, or amenities on the user device 110 before the call. These searches may give context to the telephone conversation. In another example, the user 105 may be playing or viewing certain pictures or videos or listening to certain music just before the call is made. These pictures, videos, or music may provide context to the telephone call.

In an embodiment, the user 105 may be on another telephone call with another caller just before making the current telephone call. The phone conversation and the caller of this previous telephone call may provide context to the current telephone call. In particular, the user device 110 may compare the keywords and/or key phrases of the previous call with that of the current call to determine how they are related. The more related the two calls are, the more the previous telephone call may provide context to the current telephone call.

In an embodiment, the user device 110, with the user 105's permission, may access the user 105's calendar, schedule, contact list, and/or social network accounts to provide context to the telephone call. In particular, the user device 110 may look up the user 105's calendar or schedule to determine the context of the telephone call. For example, based on the user 105's schedule or calendar, the user device 110 may determine that the telephone call is related to a business meeting or related to a certain discussion topic. In another example, based on the user 105's social network account, the user device 110 may deteilnine the relationship between the user 105 and the other caller based on the other caller's telephone number.

At step 304, the user device 110 may identify keywords or key phrases used in the telephone conversation. In particular, the user device 110 may use voice recognition techniques to identify key words and/or key phrases spoken by the user 105 and/or the other caller(s). As noted above in process 200, the user device 110 may monitor and learn the user 105's voice, language style and usage, accents, speech habit, tone of voice, and the like to improve the accuracy of voice recognition. In an embodiment, the user device 110 also may learn the other caller's voice, language style and usage, accents, and speech habit, and the like to better recognize key words and/or key phrases spoken by the other caller who has frequent telephone conversation with the user 105.

The user device 110 may recognize and identify various types of keywords. For example, the user device 110 may identify inquiry-related keywords and/or key phrases, such as the word “Who,” “What,” “When,” Where,” and/or “How.” Other inquiry-related keywords may include “wondering,” “suspecting,” “question,” and other inquiry-related keywords that may indicate that the user 105 or the other caller(s) have a question or need an answer. In another example, the user device may identify specific subject matter keywords and/or key phrases. The user device 110 may identify various subject matters, such as a person's name, a discussion topic, a movie/music title, a company's name, a technical term, a business jargon, and the like. These subject matters may provide context to the telephone conversation. The user device 110 also may detect the tone of voice of the user 105 or the other caller to determine the emotion or mental state of the user 105 or the other caller. For example, a phrase may be a question or a statement based on the tone of voice.

In still another example, the user device 110 may identify keywords and/or key phrases related to requests for action. The user device 110 may identify words and/or phrases, such as “dial,” “enter,” “input,” “say,” “press,” and other words or phrases related to requests for user action. The requests for user action may provide context to the telephone conversation. In another example, the user device 110 may identify keywords and/or key phrases related to scheduling or planning. The user device 110 may identify words and/or phrases such as “schedule,” “calendar,” “plan,” “travel,” “flight,” “appointment,” “reminder,” and other words or phrases related to scheduling and/or planning. These words and/or phrases related to scheduling and/or planning may provide context to the telephone conversation. In an example, the user device 110 may identify words/or phrases related to location or traveling. The user device 110 may identify words and/or phrases, such as “where,” “location,” “drive,” “flight,” “destination,” “route,” “airport,” “taxi,” “rental car,” “hotel,” “booking,” “reservation,” and other words related to location and/or traveling. These location and/or traveling related words and/or phrases also may provide context to the phone conversation.

In an embodiment, the user device 110 may identify music, tunes, and other non-spoken words in the telephone conversation to provide context to the telephone conversation. For example, the user device 110 may identify music played by a company when the user 105 is put on hold, music, movie, or video played in the background by the user 105 or the other caller, and other ambient noise or sound, such machine beeps or dial tones. These tunes, music, or melody may provide context to the telephone conversation.

At step 306, the user device 110 may analyze the identified words, phrases, and/or non-spoken inputs in the telephone conversation. In particular, the user device 110 may analyze words/phrase in combination with other context data, such as environmental data, time, location, identification of the other caller, previous telephone calls, and the like to determine context. In an embodiment, the user device 110 may also analyze the words and phrases in combination with the user 105's previous habits and routines.

At step 308, the user device 110 may determine the current context of the telephone conversation. The user device 110 may use probability, such as Bayesian analysis, to analyze various keywords and/or key phrases identified in the telephone conversation in combination with environmental conditions detected at the user device 110, location, time, date, the user's calendar, contact list, social network, the identity of the other caller, the habits and/or routines of the user 105 previously learned, and other factors to infer the context of the telephone conversation. In an embodiment, a probability of a potential context may be calculated based on various factors. If the probability of the potential context exceeds a certain threshold, the user device 110 may determine that the context has been identified or discovered.

At step 310, the user device 110 may determine information or application to display to the user 105 based on the identified context. For example, the user device 110 may automatically perform a search to find appropriate information to display the appropriate information to the user 105 for the user's convenience. The user device 110 also may automatically activate appropriate application(s) for the user's convenience. As such, the user 105 need not spend time or effort to find the information while talking on the phone. In an embodiment, the user device 110 may play appropriate audio recordings or videos to the user based on the context of the telephone conversation.

For example, the user device 110 may detect that the user 105 recently has been searching for flights, the user 105 just called a travel agency, the user 105 and the travel agent are having a phone conversation that includes keywords such as “schedule,” “book,” “flight number,” “airport,” and other travel related words. The user device 110 may determine that the user 105 is planning a travel schedule with a travel agency. As such, the user device 110 may display the user 105's calendar or schedule to the user 105 during the telephone conversation to help the user 105 plan his/her travel schedule.

As the telephone conversation continues to booking different flights, the user device 110 may display flight schedules of various flights to the user 105. For example, the user device 110 may recognize city names or airline names in the telephone conversation and may infer the user 105's travel schedule. When the telephone conversation is about assigning seats on the flights, the user device 110 may display a seating chart of the flight indicating locations and available seats. When the telephone conversation is about payment for the flights, the user device 110 may display payment options. When the travel agency requests payment account number or other information, the user device 110 may automatically display input mechanisms, such as virtual keyboards or keypad, for the user 105 to enter necessary information at the user device 110. In an embodiment, the user device 110 may learn of the user 105's account number or other necessary information and may automatically fill in or enter the necessary information for the user 105.

Based on the travel schedule and the phone conversation, the user device 110 may infer that the user 105 may desire to rent a car or book a hotel at the travel destination. As such, the user device 110 may search and find various rental car and/or hotel options at the destination for the user 105. The user device 110 may display these options to the user for the user's convenience. After the travel planning is completed as indicated by the telephone conversation, the user device 110 may automatically display final travel schedule including payment receipts to the user 105.

In some embodiments, the user device 110 may display or play the appropriate information to the user at a display device different from the user device 110. For example, the user device 110 may detect other display devices, such as a monitor, a screen projector, or other display devices, that are connected to or in communication with the user device 110. The user device 110 may project or transmit the information to the connected display device to be displayed by the display device. Thus, the user 105 may continue holding the user device 110 to his/her ear for telephone conversation while viewing the information on another display device.

In another example, the user device 110 may detect that the user 105 has been looking up different movie reviews and the user 105 just called up a friend. In the phone conversation with the friend, the user device 110 identifies keywords such as “movie,” “schedule,” “theater,” “where,” “when,” “ticket,” and other words or phrases related to movie planning. The user device 110 may analyze the phone conversation and determine that the user 105 may be planning to see a movie with the friend. The user device 110 may determine the location of the user 105 and the location of the friend and may find and display a list of movie theaters located near the user 105 and the friend.

The user device 110 also may recognize the name(s) of the movies the user 105 and the friend may be interested in from the telephone conversation. The user device 110 may find the showing schedule for the movies. In an embodiment, the user device 110 also may access the user 105's schedule or calendar to determine when the user 105 is available to go see the movie. The user 105's calendar may be displayed along with the movie showing schedule, such that the user 105 may determine when he/she is free to go see the movie. The user device 110 also may find reviews and other information related to the movie. In an embodiment, the user device 110 may play the music of the movie or play the trailer of the movie to the user 105 and the friend, such that the user 105 and the friend may view and discuss whether to go see the movie. Based on the time or location mentioned in the telephone conversation, the user device 110 may find the ticket prices for the movies and theaters and display the ticket prices to the user 105. Thus, the user device 110 may continuously display relevant information to the user 105 and/or the friend to help them decide which movie and/or theater to go to.

Based on the phone conversation, the user device 110 may determine that the user 105 and the friend have decided on a movie and a theater, the user device 10 may activate a ticket purchasing application automatically to facilitate ticket purchase for the user 105. Advertisements related to the movie or the theater also may be displayed to the user 105 to entice the user 105 to make additional purchases.

In another example, the user 105 may call a service provider. The service provider may request that the user 105 enter various information or select different options. The user device 110 may recognize these requests in the phone conversation and may automatically display input mechanisms, such as virtual keypad or keyboard, to allow the user to enter different information or desired options. In an embodiment, the user device 110 may recognize that the user 105 had called the service provider before and was asked for the same information. The user device 110 may recall the information, such as account number, entered previously by the user 105 for this service provider and may automatically enter the same information for the user 105 this time. As such, the user 105 need not repeat the same entry again this time.

The service provider may put the user 105 on hold. The user device 110 may recognize that the user 105 is put on hold based on the music played by the service provider. The user device 110 may display relevant advertisements to the user 105 while the user 105 is being put on hold. For example, the advertisement may entice the user 105 to user another service provider, who provides similar or better service to the user 105.

In still another example, the user 105 may be on a phone call with a friend. The user device 110 may detect that the user 105 and the friend are located near each other. The user device 110 also may identify phrases, such as “where are you,” “where is the place,” and other location inquiries. The user device 110 may automatically display a map indicating the location of the user 105, the location of the friend, and/or the location of the place mentioned in the phone conversation. Thus, the user 105 and/or the friend may find each other or may find the place they are referring to.

In another example, the user 105 may discuss a product or service during a phone call, and the user device 110 may search and find information related to the product or service. For example, the user device 110 may display information related to merchants near the user 105 that offer such a product or service. The user device 110 also may find prices of the product or service offered at different merchants for price comparison. The user device 110 may find and display discounts or offers related to the discussed product or service. Reviews regarding the product or service also may be displayed to the user 105.

In an example, the user 105 may discuss certain general topics, such as the weather, politics, science, literature, sports, news, and other various discussion topics. The user device 110 may recognize these different topics in the phone conversations and may find and display information related to these topics to the user 105. For example, the user device may search and display topics related to news, sports, politics, literature, and the like when they are mentioned in the phone conversation. As such, the user 105 may be provided with relevant information to facilitate the phone discussion.

The user device 110 may continuously monitor and analyze the user 105's telephone conversation as the user 105 continues the conversation with the other caller to update and/or determine the context and to update the displayed information. As the context of the telephone conversation may change or shift over time, the user device 110 may display different information to the user 105 based on the changing context.

By using the above process 300, the user device 110 may analyze the phone conversation of the user 105 to infer context. The user device 110 may then determine and display appropriate information to the user 105 automatically. As such, the user 105 may be provided with the appropriate screen display automatically for the user 105's convenience.

The processes 200 and 300 may be executed by the user device 110. In an embodiment, the processes 200 and 300 may be executed by a server of a service provider. In still another embodiment, the processes 200 and 300 may be executed by the user device 110 and the server in coordination with each other.

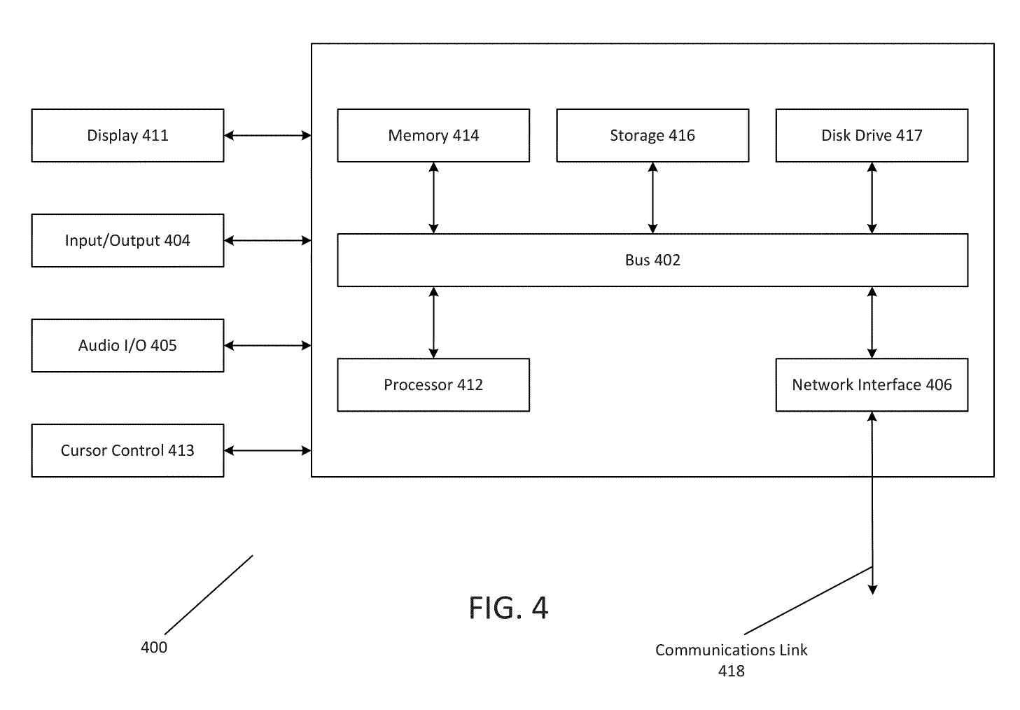

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with other communication devices and the network 160. The merchant and/or payment provider may utilize a network computing device (e.g., a network server) capable of communicating with other communication devices and the network 160. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a hardware memory storing an account of a user, and
one or more processors in communication with the memory and adapted to:
determine a context of a telephone call based on a current voice conversation of the telephone call; and
cause to be displayed information related to the context of the telephone call to the user during the current voice conversation.

2. The system of claim 1, wherein the one or more processors are further adapted to:
identify one or more key words or key phrases in the telephone call; and
analyze the one or more key words or key phrase in the telephone call to determine the context of the telephone call.

3. The system of claim 1, wherein the one or more processors are further adapted to:
identify one or more of a time, location, date, and season of the telephone call; and
analyze the one or more of the time, location, date, and season of the telephone call to determine the context of the telephone call.

4. The system of claim 1, wherein the one or more processors are further adapted to:
monitor interactions of the user with a user device of the user before the telephone call is initiated or received at the user device; and
analyze the interactions of the user with the user device to learn the context of the telephone call.

5. The system of claim 1, wherein the one or more processors are further adapted to:
monitor a previous telephone call previously initiated or received at a user device of the user before the telephone call is initiated or received at the user device; and
analyze the previous telephone call to determine the context of the telephone call.

6. The system of claim 5, wherein the one or more processors are further adapted to:
compare key words or key phrases identified in the previous telephone call with that of the telephone call to determine a degree of relatedness between the previous telephone call and the telephone call; and
determine the context of the telephone call based on the previous telephone call based on the relatedness between the telephone call and the previous telephone call.

7. The system of claim 1, wherein the one or more processors are further adapted to:
determine a relationship between the user and another caller of the telephone call based on one or more of a social network, contact list, previous call history, and online search; and
determine the context of the telephone call based on the relationship between the user and the another caller.

8. The system of claim 2,
wherein the one or more key words or key phrases are inquiry-related keywords or key phrases; and
wherein the one or more processors are further adapted to:
search for information requested in the telephone call; and
cause to be displayed the information requested in the telephone call to the user.

9. The system of claim 2,
wherein the one or more key words or key phrases are related to requests for information entry; and
wherein the one or more processors are further adapted to:
determine the information entry requested in the telephone call; and
cause to be displayed an input mechanism for receiving the information entry.

10. The system of claim 9, wherein the one or more processors are further adapted to:
determine that the information entry requested information previously entered by the user; and
automatically fill in the information entry requested in the telephone call based on the user's pervious entry.

11. The system of claim 2,
wherein the one or more key words or key phrases are related to a discussion topic; and
wherein the one or more processors are further adapted to:
search for information related to the discussion topic; and
cause to be displayed the information related to the discussion topic to the user.

12. The system of claim 11, wherein the information is displayed in one or more of a textual form, an image form, a video form, and an audio form.

13. The system of claim 2,
wherein the one or more key words or key phrases are related to scheduling or planning; and
wherein the one or more processors are further adapted to activate and display one or more applications related to scheduling or planning to the user.

14. The system of claim 2,
wherein the one or more key words or key phrases are location-related keywords or key phrases; and
wherein the one or more processors are further adapted to:
determine a location of the user; and
cause to be displayed a map or an application indicating the location of the user in relation to another call of the telephone call and/or a location of a destination.

15. The system of claim 1, wherein the context of the telephone call changes over time and the information displayed to the user is updated based on the changing context.

16. A method comprising:
determining, by a hardware processor, a context of a telephone call based on a current voice conversation of the telephone call; and
causing to be displayed, by the hardware processor, information related to the context of the telephone call to a user during the current voice conversation.

17. The method of claim 16, wherein the telephone call is made at a user device of the user and the information is displayed at another device connected to the user device.

18. The method of claim 16, further comprising:
identifying key words or key phrases in the telephone call to determine the context of the telephone call; and
causing to be displayed advertisements related to the context of the telephone call to the user.

19. The method of claim 16, further comprising:
monitoring interactions of the user with a user device of the user; and
determining user preferences for information display on the user device based on the monitored interactions.

20. A non-transitory machine-readable medium comprising a plurality of machine-readable instructions which when executed by one or more processors are adapted to cause the one or more processors to perform a method comprising:
determining a context of a telephone call based on a current voice conversation of the telephone call; and
causing to be displayed information related to the context of the telephone call to a user during the current voice conversation.
